(19) United States
(12) Patent Application Publication
(10) Pub. No.: US 2004/0126067 A1
(43) Pub. Date: Jul. 1, 2004

(54) Multi-ch optical transceiver module

(75) Inventors: Yong Yao, Sichuan Province (CN); Zhong Yang, Sichuan Province (CN); Xiaobo Tang, Sichuan Province (CN)

Correspondence Address: HOGAN & HARTSON L.L.P., 500 S. GRAND AVENUE, SUITE 1900, LOS ANGELES, CA, 90071-2611, US

(73) Assignee: FIBERXON INCORPORATION

(21) Appl. No.: 10/655,767

(22) Filed: Sep. 5, 2003

(30) Foreign Application Priority Data
Oct. 17, 2002 (CN) 02244441.6

(51) Int. Cl. G02B 6/36

(52) U.S. Cl. 385/92

(57) ABSTRACT

This invention relates to a multi-ch optical transceiver module, which comprises: (1) a plurality of optical subassembly (OSA) units, for transforming the received multi-ch optical signals to multi-ch electrical signals, and transforming the multi-ch electrical signals to be transmitted to multi-ch optical signals respectively; (2) a plurality of special signal processing IC units, for disposing the multi-ch electrical signals received from said OSA units and for outputting the multi-ch electrical signals to be transmitted to said OSA units after disposal; (3) an electrical connector unit, for outputting multi-ch electrical signals received from said special signal processing IC units and inputting multi-ch electrical signals to be transmitted to the special signal processing IC units before transmitting. This multi-ch transceiver module is mainly used at switch devices at center office of telecom and datacom network. It also can be used in high-density environment.

### FIELD OF THE INVENTION

This invention relates to an optical transceiver module used in telecom & datacom transmission layer, and more particularly, to a multi-ch optical transceiver module with multi-ch optical transmitting and receiving functions.

### BACKGROUND OF THE INVENTION

Fiber communication became the main method of modem information network with the enlarging trunk line transmission capacity of communication network and the improving rate. Optical transceiver is one of the core photoelectron parts in modem communication network. The optical transceiver is a multifunctional substantial module with Laser, PD and IC controller, completing the optical-electrical transform and the electrical-optical transform. The optical transceiver can be divided into two categories: Telecom application for long distance communication with telecommunication companies as the end-users; Datacom application for short distance communication in civil use.

As the communication equipments are becoming smaller in size, while interface density getting high, all transceivers of these two categories are developing to the orientation of miniaturization to increase the number of fiber interfaces of network equipment, such as SFF (small form factor) package module that fixed on a printed circuit board. Meanwhile, transceivers of a new generation need to support hot-pluggable function for the convenience of network maintenance and update. Therefore standard modules in GBIC and SFP (small form pluggable) package appeared. SFP and SFF have the similar size, but SFP is smaller and easier to be maintained.

Most of the present transceivers have only one channel transceiver function, and few transceiver products can be extended to 2 channels. Even with smaller size, it is still not enough to meet the demand of high-density application. Current optical multi-ch transceivers adopt strip fiber, and their performance is related to the transmitting signals. Therefore such a transceiver is not a simple superposition of several independent optical transceiver modules. As a result, its application is limited.

### SUMMARY OF THE INVENTION

The object of the present invention is to provide a multi-ch optical transceiver module with multi-channel transceiver and pluggable function without using the strip fiber.

To achieve the object, a multi-ch optical transceiver module, according to the present invention comprises:

a plurality of optical subassembly (OSA) units, for transforming the received multi-ch optical signals to multi-ch electrical signals, and transforming the multi-ch electrical signals to be transmitted to multi-ch optical signals respectively;

a plurality of special signal processing IC units, for disposing the multi-ch electrical signals received from said OSA units and for outputting the multi-ch electrical signals to be transmitted to said OSA units after disposal;

an electrical connector unit, for outputting multi-ch electrical signals received from said special signal processing IC units and inputting multi-ch electrical signals to be transmitted to the special signal processing IC units before transmitting.

### BRIEF DESCRIPTION OF THE DRAWINGS

Other features and advantages of the present invention will become apparent as following detailed description proceeds and with the reference to the drawings, where in:

FIG. 1: Front view of a multi-ch optical transceiver module, according to one embodiment of this invention;

FIG. 2: Side view of a multi-ch optical transceiver module, according to the embodiment of this invention;

FIG. 3: Bottom view of a multi-ch optical transceiver module, according to the embodiment of this invention.

FIG. 4: Shows the positions of various units at the upper case of the multi-ch optical module, according to the embodiment of this invention;

FIG. 5: Side elevation view of FIG. 4.

Throughout the drawings, the same reference numerals indicate similar or corresponding feature or functions.

### DETAILED DESCRIPTION

While not wishing to be bound by example, the following detailed description will proceed with reference to a 4-channel optical transceiver module as an embodiment of the present invention.

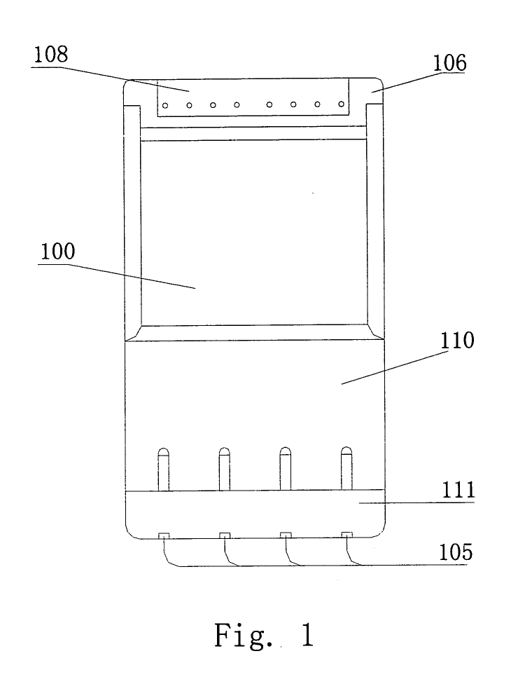

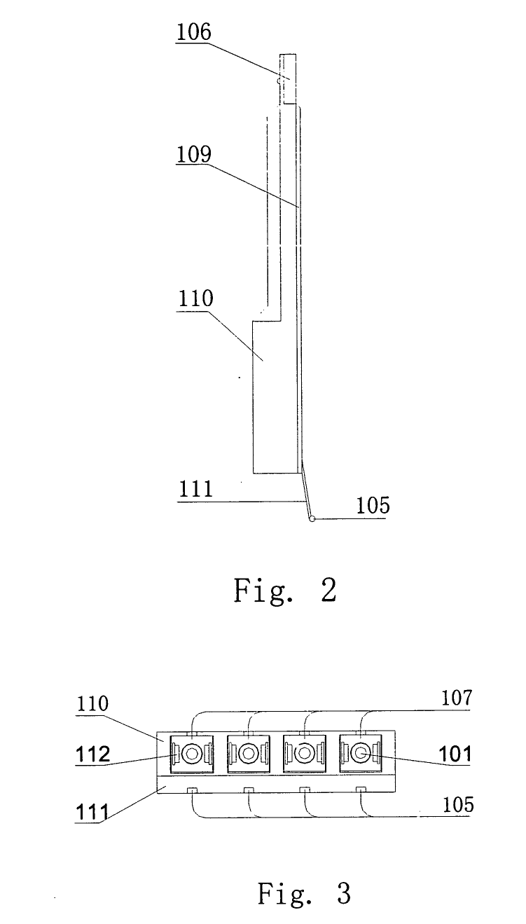

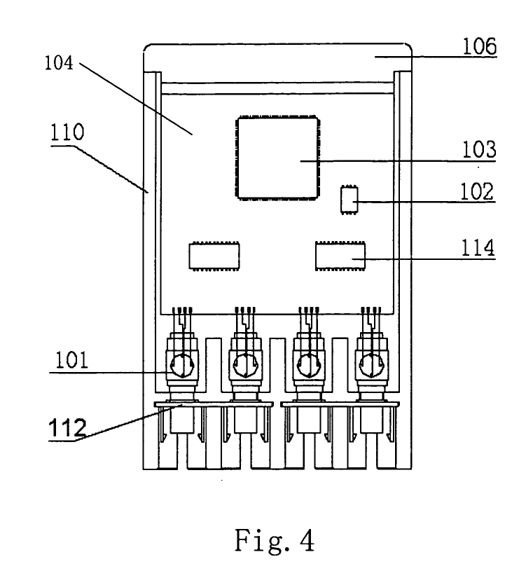

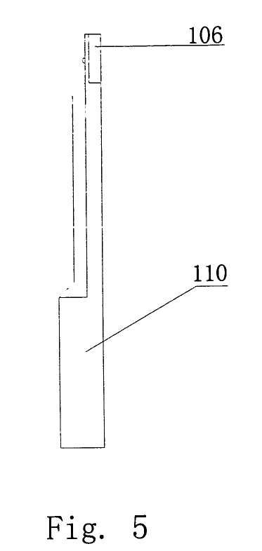

FIG. 1 to FIG. 5 shows the composition of 4-channel optical transceiver module 100:

A module case unit of the 4-channel optical transceiver module 100 comprise an upper case 110 and a base case 109 with compression joint or lock joint; an electrical connector unit 106 placed at the upper case 110 at the rearward of the module case unit. This electrical connector unit 106 is connected with an external device for outputting multi-ch electrical signals received from the 4-channel optical transceiver module 100 to the external device, or inputting multi-ch electrical signals received from the external device to the 4-channel optical transceiver module 100. The electrical connector unit 106 may be the PCMCIA 68 pins connector. For 4-channel optical transceiver module of this embodiment, a single row electrical connector could be adopted as electrical connector unit 106. To avoid electromagnetic interference, aroused from electrical signal transmission of electrical connector 106, a special PC card ESD grounding unit 108 matching with the electrical connector 106 could be put at electrical connector unit 106 for shielding the electromagnetic interference during bi-directional signal transmission with the external device.

A plurality of special signal process IC units 114 are placed at upper case 110 of the 4-channel optical transceiver module 100, jointed to the electrical connector unit 106. This special signal processing IC units 114 is jointed to a plurality of OSA units 101 at upper case 110 for the bi-directional signal transmission between the electrical connector unit 106 and the OSA units 101, that is, inputting multi-ch electrical signals to be transmitted from the electrical connector unit 106 to the OSA units 101 after disposal, or receiving multi-ch electrical signals from the OSA units 101 and outputting them to the external device through the electrical connector unit 106 after disposal.

The plurality of OSA units 101 are respectively put into four independent grooves at the upper case 110 of the 4-channel optical transceiver module 100, and fixed to the upper case 110 through four optical connector mounting 112. The optical connector unit 107 consisting of a plurality of OSA units 101 and optical connector mountings 112 is the outside optical interface of the 4-channel optical transceiver module according to this invention, it can transform received multi-ch optical signals to multi-ch electrical signals, then offer them to the special signal process IC units 114 for disposal, and also can transform the multi-ch electrical signals getting from the special signal process IC units 114 to multi-ch optical signals to realize bi-direction optical transmission in single fiber. The optical connector unit 107 connects the outside fiber through SC optical connector, and the gap of the SC optical connector of this embodiment is upward.

In the multi-channels optical transceiver module of present invention, the OSA units 101 can be placed not only on the upper case 110 but also the base case of the module case unit or the fixed board in the module case unit.

In order to monitor the real time operation state of the OSA units 101 and the special signal process IC units 114 during the working of the 4-channel optical transceiver module 100, there is a MPU (micro processing unit) 103 in the module case for monitoring and outputting the real time monitoring information. An EEPROM 102 recording the monitoring information from the MPU 103 is also available. The information in the EEPROM 102 can be transmitted to an outside monitor device through an I²C bus.

Above-mentioned MPU 103, EEPROM 102 and a plurality of special signal process IC units 114 can be set at a printed circuit board unit 104, and the printed circuit board unit 104 can be placed not only at the upper case 110 but also the base case of the module case unit or the fixed board in the module case unit. Through pins linked to printed circuit board unit 104, the special signal process IC units 114 and the MPU 103 are respectively connected to the OSA units 101 to realize the bi-directional signal transmission between special signal process IC units 114 and OSA units 101, and MPU 103 monitoring over the OSA units 101. A handle 111 jointed to the base case 109 or the upper case 110 of the module case unit for easily plugging in or pulling out the 4-channel optical transceiver module 100. The jointing method between the handle 111 and the base case 109 or the upper case 110 of the module case unit is compression joint or lock joint. An indicator light 105 could also be set in the leading face of the 4-channel optical transceiver module 100 to indicate the operation state of the module.

Above paragraphs, as well as figures, describe the 4-channel optical transceiver module 100 of this invention. In operation of this optical transceiver module 100, bi-direction signal transmission involves the following steps:

When receiving signals, every OSA of the OSA units 101 carries out optical-electrical transform of received multi-ch optical signals according to the rule that each OSA transforms one channel optical signal to one channel electrical signal, then the multi-ch electrical signals after disposal of special signal processing IC units 114 is output to the external device through the electrical connector unit 106;

When transmitting signals, the electrical connector unit 106 receives the single channel or multi-ch transmitting electrical signals from the external device, and sends it to the special signal processing IC units 114. The multi-ch electrical signals after disposal of the special signal processing IC units 114 is then output to the OSA units 101. After electrical-optical transformation, the electrical signals for transmitting are sent to the destination according to the rule that each OSA transforms one channel electrical signal to one channel optical signal.

During the process of the bi-directional signal transmission, MPU 103 monitors the operation status of OSA units 101 and special signal process IC units 114. The relative monitoring information is reported to outside monitoring device through the I²C bus, or recorded at EEPROM 102 first, and provided to outside monitoring devices when inquired.

Above paragraphs describe the multi-channels optical transceiver module of the present invention by taking 4-channel optical transceiver module as an example. And the multi-channels optical transceiver module could be extended to 8-channel or more in actual application. If 8-channel optical transceiver module is adopted, all technical parameters and correspondent technical standards of optical connectors unit 107, optical connector connected with fiber and the electrical connector 106 should be met.

Profitable Effect

In the above, the present invention has been illustrated in conjunction with drawings. It is apparent that a multi-ch optical transceiver module is provided without using strip fiber, and equivalent to simple superposition of signals from a plurality of channels without signal interference. The present invention also offers abundant monitoring information collected by the built-in MPU. In general, the multi-ch optical transceiver module is convenient with high performance, and especially suitable for high-density application such as switcher device at telecommunication center office.

While the invention has been described in conjunction with specific embodiments, it is evident that many alternatives, modifications and variations will be apparent to those skilled in the art in light of the foregoing description. Accordingly, it is intended to embrace all such alternatives, modifications and variations as fall within the spirit and scope of the appended

What is claimed is:

1. A multi-ch optical transceiver module, comprising:
a) a plurality of optical subassemblies (OSA) for transforming the received multi-ch optical signals to multi-ch electrical signals, and transforming the multi-ch electrical signals to multi-ch optical signals separately for transmission;
b) a plurality of special signal processing IC units for disposing the multi-ch electrical signals received from the plurality of OSA units and for inputting multi-ch electrical signals to the plurality of OSA units for transmission;
c) an electrical connector unit for outputting multi-ch electrical signals disposed by the special signal processing IC units and for providing received multi-ch electrical signals to the special signal processing IC units for disposal;

2. The multi-ch optical transceiver module of claim 1, further comprising a MPU, for monitoring operation status of said plurality of OSA units and said special signal processing IC units so as to send out monitoring information.

3. The multi-ch optical transceiver module of claim 2, further comprising an EEPROM, for recording said monitoring information.

4. The multi-ch optical transceiver module of claim 3, further including an ESD grounding unit, for shielding the electromagnetic interference aroused when electrical connector unit transmits electrical signal.

5. The multi-ch optical transceiver module of claim 4, further including a plurality of optical connector mounting sets, for fixing said plurality of OSA units.

6. The multi-ch optical transceiver module of claim 5 is put in a module case unit comprising an upper case and a base case, wherein a handle is jointed to the base case or the upper case of the module case unit for easy plug-in or pullout the multi-ch optical transceiver module.

7. The multi-ch optical transceiver module of claim 6, wherein at least one indicating light is set in the leading face of the multi-channels optical transceiver module to indicate the operation state of the module according to said monitoring information.

8. The multi-ch optical transceiver module of claim 6, wherein said special signal processing IC units, said MPU and said EEPROM are set at a printed circuit board.

9. The multi-ch optical transceiver module of claim 8, wherein said printed circuit board is placed on a fixed board in said module case unit, the upper case, or the base case of said module case unit.

10. A multi-ch optical transceiver module as stated in claim 8, wherein the multi OSA are placed on the fixed board in the relate module case unit, the upper case, or the base case of the relate module case unit.
